(19) United States
(12) Patent Application Publication
(10) Pub. No.: US 2015/0010875 A1
(43) Pub. Date: Jan. 8, 2015

(54) THERMAL ENERGY STORAGE WITH MOLTEN SALT

(71) Applicant: Halotechnics, Inc., Emeryville, CA (US)

(72) Inventors: Justin Raade, San Francisco, CA (US); John Vaughn, Pacifica, CA (US); Benjamin Elkin, San Francisco, CA (US)

(21) Appl. No.: 14/375,409

(22) PCT Filed: Jan. 31, 2013
(86) PCT No.: PCT/US13/24131

§ 371 Date: Jul. 29, 2014

Related U.S. Application Data
(60) Provisional application No. 61/592,859, filed on Jan. 31, 2012.

(51) Int. Cl. C09K 5/12

(52) U.S. Cl. CPC C09K 5/12
USPC 432/9; 252/71

(57) ABSTRACT

Several systems of thermally stable inorganic salts with low melting points are disclosed. These compositions include sodium, potassium, zinc, chloride, and sulfate and can have thermal stability limits greater than 700° C.

### CROSS-REFERENCES TO RELATED APPLICATIONS

This application claims priority to U.S. Provisional Application No. 61/592,859, filed Jan. 31, 2012, which is incorporated in its entirety herein for all purposes.

### STATEMENT AS TO RIGHTS TO INVENTIONS MADE UNDER FEDERALLY SPONSORED RESEARCH AND DEVELOPMENT

This invention was made with Government support under Grant No, DE-FG36-08GO18144 awarded by the Department of Energy. The Government has certain rights in this invention.

### BACKGROUND OF THE PRESENT INVENTION

Current commercially deployed thermal storage systems are two-tank sensible heat designs using molten salt as the thermal storage media [S. Relloso and E. Delgado, “Experience with molten salt thermal storage,” SolarPACES, 2009]. The most significant drawback of this technology is its high capital cost—over $80/kWht [J. Stekli, “Thermal Energy Storage Research,” ARPA-E Thermal Storage Workshop, 2011]. Today's plants using this technology have a small temperature difference between the hot tank (at 400° C.) and the cold tank (at 300° C.).

Molten salts of many varieties are currently available in large commercial quantities from several suppliers. The current standard heat transfer fluid (HTF) considered for central receiver applications is called “draw salt” (a mixture of sodium nitrate and potassium nitrate, sold under the brand name Hitec) with a melting point of 240° C. and a maximum temperature of 593° C. [“Hitec solar salt,” Coastal Chemical Co., LLC]. This relatively narrow operating range limits the performance of central receiver plants. On the upper end, current plants are limited to 565° C. operating temperature due to increasing thermal breakdown of draw salt at higher temperatures.

Increasing the maximum fluid output temperature of central receiver plants from 565° C. to 700° C. would enable the plant to produce more electricity from the same energy input by increasing the thermal conversion efficiency of the power block. Today's steam turbines used for commercial CSP plants achieve a gross conversion efficiency of just 38% [“Concentrating Solar Power Projects: Andasol-1,” NREL, 2011], constrained primarily by their lower operating temperature (under 400° C.). A state of the art supercritical steam turbine with an inlet temperature of 620° C. can achieve a conversion efficiency of approximately 45%. A molten salt material and thermal storage system with operating temperatures tailored to commercially available steam turbines could therefore dramatically improve system efficiency. This improvement would reduce the levelized energy cost [G. J. Kolb, “Conceptual design of an advanced trough utilizing a molten salt working fluid,” presented at SolarPACES Symposium, Las Vegas, Nev., 2008]. A higher operating temperature would also reduce thermal storage costs by using a greater temperature differential for sensible heat storage.

Accordingly, there exists a need for an affordable molten salt heat transfer fluid that is composed of low-cost materials and exhibits a broad operating temperature range and high thermal stability. Surprisingly, the present invention addresses this and other needs.

### BRIEF SUMMARY OF THE PRESENT INVENTION

In a first aspect, the present invention provides a composition containing: a sodium cation, in an amount of from about 0 to about 40 mol % based on the cations; a potassium cation, in an amount of from about 1 to about 90 mol % based on the cations; a zinc cation, in an amount of from about 5 to about 95 mol % based on the cations; a chloride anion in an amount of from about 40 to about 99 mol % based on the anions; and a sulfate anion in an amount of from about 1 to about 60 mol % based on the anions.

In a second aspect, the invention provides a method for storing thermal energy. The method includes heating a composition with thermal energy, wherein the composition contains: a sodium cation, in an amount of from about 0 to about 40 mol % based on the cations; a potassium cation, in an amount of from about 11 to about 90 mol % based on the cations; a zinc cation, in an amount of from about 5 to about 95 mol % based on the cations; a chloride anion in an amount of from about 40 to about 100 mol % based on the anions; and a sulfate anion in an amount of from about 0 to about 60 mol % based on the anions, thereby causes the temperature of the composition to increase.

### BRIEF DESCRIPTION OF THE DRAWINGS

FIG. 1 shows the differential scanning calorimetry trace for a sodium-potassium-zinc-chloride salt mixture.

FIG. 2 shows a phase diagram plotting the liquidus temperature in degrees Celsius for various Na—K—Zn—Cl mixtures.

FIG. 3 shows a phase diagram plotting the liquidus temperature in degrees Celsius for various Na—K—Zn—Cl mixtures.

FIG. 4 shows representative phase diagrams plotting the liquidus temperature in degrees Celsius for Na—K—Zn—Cl mixtures containing varying levels of sulfate.

### DETAILED DESCRIPTION OF THE PRESENT INVENTION

### I. General

The present invention provides new molten salt materials suitable for heat transfer and thermal energy storage applications. The surprising properties of the inventive compositions—including melting points near 200° C., thermal stabilities exceeding 700° C., and vapor pressures less than 1 bar at 700° C. were discovered by analyzing thousands of different combinations of salts using a combinatorial process. These advanced molten salts can greatly reduce thermal energy storage costs.

### II. Definitions

“Cation” refers to chemical elements or counterions having a positive charge. The positive charge can be +1, +2, +3, or greater. Exemplary cations of the present invention include, but are not limited to, potassium (K⁻), sodium (Na⁺), and zinc (Zn²⁺) cations. Other cations are useful in the present invention.

“Anion” refers to chemical elements and counterions having a negative charge. The negative charge can be −1, −2, −3, or greater. Exemplary anions of the present invention include chloride (Cl⁻) and sulfate (SO₄²⁻) anions. Other anions are useful in the present invention.

“Thermal energy” refers to portion of energy in a system that gives rise to the temperature of the system. A “thermal source” refers to a member of the system from which thermal energy is transferred to other members of the system. Thermal energy can include, for example, radiation of varying wavelengths including, but not limited to, wavelengths in the infrared and visible portions of electromagnetic spectrum. Thermal energy can also include heat in fluids or solids which can be transferred by convection or conduction. Thermal energy can also be generated by mechanical compression or electrical resistive elements. Thermal energy is transferred between members of the system as heat. “Heating” a composition of the invention refers to raising the temperature of the composition. Heating can be conducted by processes including, but not limited to, convection, conduction, mechanical compression, electrical resistive heating, and irradiation. Examples of thermal sources include, but are not limited to, natural sources such as sunlight and geothermal sources. Examples of thermal sources also include systems such as power plants and components thereof.

### III. Compositions

Molten salts exhibit many desirable heat transfer qualities at high temperatures. They have high density, high heat capacity, high thermal stability, and very low vapor pressure even at elevated temperatures. Their viscosity is low enough for sufficient pumping at high temperatures, and many are compatible with common stainless steels.

Accordingly, the present invention provides a composition containing a sodium cation, a potassium cation, a zinc cation, a chloride anion, and a sulfate anion. As used herein, the terms “sodium,” “potassium,” and “zinc” refer to the corresponding cations unless otherwise specified. “Chloride” and “sulfate” refer to the anions. In some embodiments, the present invention provides a composition containing: a sodium cation, in an amount of from about 0 to about 40 mol % based on the cations; a potassium cation, in an amount of from about 1 to about 90 mol % based on the cations; a zinc cation, in an amount of from about 5 to about 95 mol % based on the cations; a chloride anion in an amount of from about 40 to about 99 mol % based on the anions; and a sulfate anion in an amount of from about 1 to about 60 mol % based on the anions.

In some embodiments, the present invention provides a composition consisting essentially of sodium, potassium, zinc, chloride, and sulfate in any of the amounts described herein. In some embodiments, the composition consists of sodium, potassium, zinc, chloride, and sulfate in any of the amounts described herein.

Any suitable amount of sodium can be used in the compositions of the present invention. In general, the compositions can include from about 0 mol % to about 40 mol % sodium (based on the cations in the composition). In some embodiments, the compositions can include, for example, from about 0 mol % to about 26 mol % sodium, or from about 8 mol % to about 18 mol % sodium, or from about 1 mol % to about 34 mol % sodium, or from about 8 mol % to about 32 mol % sodium, or about 20 mol % sodium. In some embodiments, the compositions can include about 0, 1, 2, 3, 4, 5, 6, 7, 8, 9, 10, 11, 12, 13, 14, 15, 16, 17, 18, 19, 20, 21, 22, 23, 24, 25, 26, 27, or 28 mot % sodium. In some embodiments, the composition includes a sodium cation in an amount of from about 0 to about 28 mol % based on the cations. In some embodiments, the composition can include the sodium cation in an amount of from about 5 to about 20 mol % based on the cations.

Any suitable amount of potassium can be used in the compositions of the present invention. In general, the compositions can include from about 1 mol % to about 90 mol % potassium (based on the cations in the composition). In some embodiments, the compositions can include, for example, from about 8 mol % to about 40 mol % potassium, or from about 40 mol % to about 64 mol % potassium, or from about 4 mol % to about 42 mol % potassium, or from about 8 mol % to about 82 mol % potassium, or about 20 mol % potassium. In some embodiments, the compositions can include about 5, 10, 25, 30, 35, 40, 45, 50, 55, 60, or 65 mol % potassium. In some embodiments, the invention provides a composition wherein the potassium cation is present in an amount of from about 8 to about 40 mol % based on the cations. In some embodiments, the invention provides a composition wherein the potassium cation is present in an amount of from about 35 to about 65 mol % based on the cations.

Any suitable amount of zinc can be used in the compositions of the present invention. In general, the compositions can include from about 5 mol % to about 95 mol % zinc (based on the cations in the composition). In some embodiments, the compositions can include, for example, from about 24 mol % to about 62 mol % zinc, or from about 62 mol % to about 65 mol % zinc, or from about 50 mol % to about 94 mol % zinc, or from about 8 mol % to about 80 mol % or about 60 mol % zinc. In some embodiments, the compositions can include about 20, 22, 24, 26, 28, 30, 32, 34, 36, 38, 40, 42, 44, 46, 48, 50, 52, 54, 56, 58, 60, 62, 64, 66, or 68 mol % zinc. In some embodiments, the invention provides a composition wherein the zinc cation is present in an amount of from about 20 to about 68 mol % based on the cations. In some embodiments, the invention provides a composition wherein the zinc cation is present in an amount of from about 60 to about 65 mol % based on the cations.

Any suitable amount of chloride can be used in the compositions of the present invention. In general, the compositions can include from about 40 mol % to about 99 mol % chloride (based on the anions in the composition). In some embodiments, the compositions can include, for example, from about 95 mol % to about 98 mol % chloride, or from about 56 mol % to about 76 mol % chloride. In some embodiments, the compositions can include about 50, 52, 54, 56, 58, 60, 62, 64, 66, 68, 70, 72, 74, 76, 78, 80, 82, 84, 86, 88, 90, 92, 94, 96, or 98 mol % chloride. In some embodiments, the invention provides a composition wherein the chloride anion is present in an amount of from about 95 to about 99 mol % based on the anions. In some embodiments, the invention provides a composition wherein the chloride anion is present in an amount of from about 50 to about 80 mol % based on the anions.

Any suitable amount of sulfate can be used in the compositions of the present invention. In general, the compositions can include from about 1 mol % to about 60 mol % sulfate (based on the anions in the composition). In some embodiments, the compositions can include, for example, from about 22 mol % to about 44 mol % sulfate, or from about 2 mol % to about 4 mol % sulfate. In some embodiments, the compositions can include about 1, 2, 3, 4, 5, 6, 8, 10, 12, 14, 16, 18, 20, 22, 24, 28, 30, 32, 34, 36, 38, 40, 42, 44, 46, or 48 mol % sulfate. In some embodiments, the invention provides a composition wherein the sulfate anion is present in an amount of from about 1 to about 5 mol % based on the anions. In some embodiments, the invention provides a composition wherein the sulfate anion is present in an amount of from about 20 to about 45 mol % based on the anions.

In some embodiments, the invention provides a composition containing the sodium cation, in an amount of from about 8 to about 16 mol % based on the cations; the potassium cation, in an amount of from about 40 to about 64 mol % based on the cations; the zinc cation, in an amount of from about 24 to about 44 mol % based on the cations; the chloride anion, in an amount of from about 55 to about 75 mol % based on the anions; and the sulfate anion, in an amount of from about 25 to about 45 mol % based on the anions.

In some embodiments, the invention provides a composition containing: the sodium cation, in an amount of from about 8 to about 16 mol % based on the cations; the potassium cation, in an amount of from about 40 to about 64 mol % based on the cations: the zinc cation, in an amount of from about 44 to about 62 mol % based on the cations; the chloride anion, in an amount of from about 55 to about 75 mol % based on the anions; and the sulfate anion, in an amount of from about 25 to about 45 mol % based on the anions.

In some embodiments, the invention provides a composition containing: the sodium cation, in an amount of from about 0 to about 26 mol % based on the cations: the potassium cation, in an amount of from about 8 to about 40 mol % based on the cations; the zinc cation, in an amount of from about 60 to about 66 mol % based on the cations; the chloride anion, in an amount of from about 95 to about 99 mol % based on the anions; and the sulfate anion, in an amount of from about 1 to about 5 mol % based on the anions.

The compositions of the present invention can be prepared by any method known to one of skill in the art. For example, salt components can be dispensed into a suitable container, such as a crucible, and weighed using a scientific balance accurate to 0.01 mg. Salt mixtures can be formulated using automated equipment for measuring each component as it is being dispensed and recording the final weight of a given mixture. A salt mixture can be ground with a mortar and pestle, prior to melting and homogenization in a furnace under suitable conditions. The mixture can be heated, for example, in a furnace at 150° C. for 4 hours to remove any water absorbed in the salt. The mixture can be further heated to ensure complete melting and homogenization. For example, the mixture can be heated for an additional 8 hours at 500° C. The compositions can be stored with a desiccant until characterized and/or used.

Typically, a sample containing 250 mg of a salt mixture is suitable for analyzing physical properties. A 30 kWht thermal storage prototype requires approximately 290 kg of molten salt. The equation for thermal energy storage is:

Q=mcₚ(Tₕₒₜ−T_{cold})

Where cₚ is the measured value for heat capacity (i.e., the amount of energy required to raise the temperature of the salt by one degree), Tₕₒₜ−T_{cold}=400° C. for the difference in temperature between the hot tank and cold tank, and Q=30 kWht for the desired amount of stored energy. This equation can be solved for the required storage media mass m. To produce the required quantity of molten salt, raw materials can be procured from commercial vendors. The necessary salt inventory can be manufactured using a process called spray drying. In this process, salt components are first dissolved in water and then atomized so as to dehydrate the mixture in the air and yield a fine powder product. The powdered state eases handling and loading logistics of the salt into the thermal storage system. The composition of the final powder product can be verified using standard chemical analysis techniques.

A composition of the present invention can be described by specifying its composition, melting point, and thermal stability. Additional properties that are relevant for heat transfer fluid applications include the viscosity, specific heat, thermal conductivity, density, and vapor pressure. These properties can be measured using standard methods. The materials compatibility of the present invention with common alloys of steel is also important; this property can be measured with custom corrosion hardware.

A molten salt with a broad operating range (low melting point, high thermal stability) is useful for applications in addition to concentrating solar power, such as grid scale electricity storage with a reversible heat pump/heat engine, in-situ oil shale conversion, heat transfer and heat storage with industrial processes, heat treating of metals, and as an electrolyte in thermal batteries [P. Masset and R. Guidotti, “Thermal activated (thermal) battery technology Part II. Molten salt electrolytes,” J. Power Sources, vol. 164, pp, 397-414, 2007]. For heat pump electricity storage applications, the high temperature molten salt reduces the cost of storage and increases the round trip efficiency of the storage system. For oil shale applications, the molten salt would be used as a heat transfer fluid to transport heat from a thermal source to an underground shale formation and convert the shale at high temperature to a liquid hydrocarbon that could be extracted. For heat treating applications, the chemical interaction of the present invention with the heat treated metal should be understood in the relevant temperature range. For electrolyte applications, the ionic conductivity of the present invention should be measured as well as the compatibility with anode and cathode materials. Extensive data exists for binary and ternary phase diagrams of inorganic salts [Phase Diagrams for Ceramists, American Ceramic Society/NIST, vol. 1-4, 7, 1964-1989.].

The compositions of the present invention can have any suitable melting point. The melting point can be, for example, less than about 300° C., or less than about 275° C., or less than about 250° C., or less than about 225° C., or less than about 200° C. The melting point can be about 180, 185, 190, 195, 200, 205, 210, 215, 220, 225, 230, 235, 240, 245, 250, 255, 260, or 265° C. In some embodiments, the invention provides a composition wherein the melting point is less than about 300° C. In some embodiments, the invention provides a composition wherein the melting point is about 200° C.

The compositions of the present invention can have any suitable thermal stability limit. The thermal stability limit can be, for example, greater than about 400° C., or greater than about 450, 500, 550, 600, 650, or 700° C. In some embodiments, the composition has a thermal stability limit greater than about 565° C. In some embodiments, the invention provides a composition wherein the thermal stability limit is at least about 700° C.

The melting point of a mixture can be determined by heating a sample at a controlled rate and using an optical method to record the temperature at which each mixture transitions from opaque to clear. This transition corresponds to the liquidus temperature, which is defined as the temperature during heating at which the last remaining solid phase melts and becomes liquid. The liquidus temperature is also equivalent to the temperature during cooling at which a solid phase first appears in the melt. A differential scanning calorimeter (DSC) can also be used to measure the melting point of a composition, as well as other relevant thermal properties including heat of fusion and heat capacity. Suitable calorimeters include the Netzsch 404 Fl Pegasus DSC.

The thermal stability limit of a mixture can be measured using a thermogravimetric analysis (TGA) device. The TGA device heats a sample in a controlled environment and continuously measures the sample weight, which typically decreases at higher temperatures as the sample decomposes into gaseous products. The thermal stability limit of a sample can be assessed by determining the temperature at which it has lost a defined percentage of its anhydrous weight during a TGA temperature ramp. Certain TGA devices, such as the TA Instruments Q500 TGA, can achieve temperatures of up to 1000° C. Testing can be conducted and compared under different atmospheres, such as a reactive atmosphere (e.g., air) or an inert atmosphere (e.g., nitrogen), in order to determine the effects of oxidation on the thermal stability limit.

### IV. Methods or Storing Thermal Energy

In another aspect, the present invention provides a method for storing thermal energy. The method includes heating a composition with thermal energy, wherein the composition contains: a sodium cation, in an amount of from about 0 to about 40 mol % based on the cations; a potassium cation, in an amount of from about 1 to about 90 mol % based on the cations; a zinc cation, in an amount of from about 5 to about 95 mol % based on the cations; a chloride anion in an amount of from about 40 to about 100 mol % based on the anions; and a sulfate anion in an amount of from about 0 to about 60 mol % based on the anions. Heating the composition with thermal energy causes the temperature of the composition to increase.

Any of the compositions described above can be useful in the methods of the present invention. Furthermore, compositions containing a chloride anion in the amount of about 100 mol % (based on the anions) can be used in the methods of the invention.

In some embodiments, the invention provides a method wherein the composition contains: the sodium cation, in an amount of from about 1 to about 40 mol % based on the cations; the potassium cation, in an amount of from about 1 to about 90 mol % based on the cations; the zinc cation, in an amount of from about 5 to about 95 mol % based on the cations; the chloride anion in an amount of from about 40 to about 99 mol % based on the anions; and the sulfate anion in an amount of from about 1 to about 60 mol % based on the anions.

In some embodiments, the invention provides a method wherein the composition contains: the sodium cation, in an amount of from about 8 to about 16 mol % based on the cations; the potassium cation, in an amount of from about 40 to about 64 mol % based on the cations; the zinc cation, in an amount of from about 24 to about 44 mol % based on the cations; the chloride anion, in an amount of from about 55 to about 75 mol % based on the anions; and the sulfate anion, in an amount of from about 25 to about 45 mol % based on the anions.

In some embodiments, the invention provides a method wherein the composition contains: the sodium cation, in an amount of from about 8 to about 16 mol % based on the cations; the potassium cation, in an amount of from about 40 to about 64 mol % based on the cations; the zinc cation, in an amount of from about 44 to about 62 mol % based on the cations; the chloride anion, in an amount of from about 55 to about 75 mol % based on the anions; and the sulfate anion, in an amount of from about 25 to about 45 mol % based on the anions.

In some embodiments, the invention provides a method wherein the composition contains: the sodium cation, in an amount of from about 0 to about 26 mol % based on the cations; the potassium cation, in an amount of from about 8 to about 40 mol % based on the cations; the zinc cation, in an amount of from about 60 to about 66 mol % based on the cations; the chloride anion, in an amount of from about 95 to about 99 mol % based on the anions; and the sulfate anion, in an amount of from about 1 to about 5 mol % based on the anions.

In some embodiments, the invention provides a method wherein the composition contains: the sodium cation, in an amount of from about 1 to about 40 mol % based on the cations; the potassium cation, in an amount of from about 1 to about 90 mol % based on the cations; the zinc cation, in an amount of from about 5 to about 95 mol % based on the cations; and the chloride anion in an amount of about 100 mol % based on the anions. In some embodiments, the composition contains: the sodium cation, in an amount of from about 10 to about 34 mol % based on the cations; the potassium cation, in an amount of from about 5 to about 41 mol % based on the cations; and the zinc cation, in an amount of from about 50 to about 94 mol % based on the cations. In some embodiments, the composition contains: the sodium cation, in an amount of from about 10 to about 30 mol % based on the cations; the potassium cation, in an amount of from about 10 to about 80 mol % based on the cations; and the zinc cation, in an amount of from about 10 to about 80 mol % based on the cations. In some embodiments, the composition contains: the sodium cation, in an amount of from about 16 to about 26 mol % based on the cations; the potassium cation, in an amount of from about 20 to about 40 mol % based on the cations; and the zinc cation, in an amount of from about 42 to about 60 mol % based on the cations.

In some embodiments, the invention provides a method wherein the composition contains: the sodium cation, in an amount of about 23 mol % based on the cations; the potassium cation, in an amount of about 33 mol % based on the cations; the zinc cation, in an amount of about 44 mol % based on the cations; and the chloride anion in an amount of about 100% based on the anions.

In some embodiments, the invention provides a method wherein the composition contains: the sodium cation, in an amount of about 20 mol % based on the cations; the potassium cation, in an amount of about 20 mol % based on the cations; the zinc cation, in an amount of about 60 mol % based on the cations; and the chloride anion in an amount of about 100% based on the anions.

In some embodiments, compositions consisting essentially of any of the salt mixtures described above are used in the methods of the invention. In some embodiments, compositions consisting of any of the salt mixtures described above are used in the methods of the invention.

As described above, heating the composition with or otherwise exposing the composition to thermal energy causes the temperature of the composition to increase. The temperature of the composition can increase, for example, by from about 1° C. to about 750° C. In some embodiments, the temperature of the composition can increase by about 5° C., 10, 25, 50, 100, 150, 200, 250, 300, 350, 400, 450, 500, 550, 600, 650, or by about 700° C. The temperature of the composition can increase to a temperature of about 30, 50, 100, 150, 200, 250, 300, 350, 400, 450, 500, 550, 600, 650, 700° C., or greater. Other temperatures or temperature increases can be achieved depending on factors including, but not limited to, the source of the thermal energy and the environment in which the composition is placed.

Any suitable source of thermal energy can be used in the methods of the invention. Useful thermal sources include, but are not limited to, a concentrated solar power plant, a fossil fuel power plant, a nuclear power plant, sunlight, a geothermal source, fuel combustion, and a heat pump. In some embodiments, the invention provides a method for storing thermal energy as described above, wherein the thermal energy originates from a source selected from the group consisting of sunlight, a concentrated solar power plant, a fossil fuel power plant, fuel combustion, and a heat pump.

Various apparatuses for concentrated solar power (CSP) are known in the art and are suitable for use in the methods of the present invention. The inventors have designed an improved laboratory scale mini-CSP plant, with several important components developed with an eye toward scalability to commercial size. A pipe passing through a tube furnace, a molten salt pump with a long-shaft design, and a 700° C. tank that is internally insulated with commercially available ceramics. This tank design will lend itself to scale-up for storage of thousands of tons of salt and eliminate the need fur expensive nickel alloy construction. The new system increases by a factor of four the temperature difference in the storage system, resulting in equal heat being stored with ¼th the material relative to the state of the art technology. A significant reduction in the cost per unit energy stored when the inventive system is implemented on a commercial scale, even when the higher cost of high temperature structural materials is included in the cost estimate. The system is described in U.S. patent application Ser. No. 13/491,058, the entirety of which is incorporated herein by reference.

### EXAMPLES

### General

Salt mixtures were formulated and characterized with an automated materials discovery workflow. The first step was to prepare free flowing anhydrous salt components. Components were purchased in reagent grade purity, typically 99% pure, from Sigma Aldrich (St. Louis, Mo.). Each component that was available in anhydrous form was ground with a mortar and pestle and dehydrated in an oven at 115° C. for at least 12 hours, except for zinc chloride which was dissolved in distilled water to obtain a 40% by weight aqueous solution. Salt mixtures were formulated using automated robotic systems for dispensing powdered and liquid materials. The powder dispensing system was the MTM Powdernium from Symyx Technologies (Sunnyvale, Calif.). This device measures each component as it is being dispensed and records the final weight with high accuracy. The liquid dispensing system was the Core Module from Symyx Technologies (Sunnyvale, Calif.). This device measures the volume of each component and records the final volume with high accuracy. Both devices can dispense many different components to many different mixtures. The mixtures were dispensed into a borosilicate glass plate containing 96 wells in an 8 by 12 array. Each mixture had a total mass of 250 mg. After dispensing, the plate was placed in a furnace purged with nitrogen gas and heated to 500° C. for at least 8 hours in order to ensure complete melting and homogenization of each mixture. After melting the plate was allowed to cool and stored in a desiccator until subsequent testing.

The melting point of each mixture was measured with a Parallel Melting Point Workstation (PMP) from Symyx Technologies (Sunnyvale, Calif.). The PMP allows the melting point for each mixture in the 96 well plate to be measured simultaneously. The PMP heats the plate at a controlled rate and uses an optical method to record the temperature at which each mixture transitions from opaque to clear. This transition corresponds to the liquidus temperature, which is defined as the temperature during heating at which the last remaining solid phase melts and becomes liquid. The liquidus temperature is also equivalent to the temperature during cooling at which a solid phase first appears in the melt (assuming no supercooling). However, supercooling is common with molten salts and therefore only data acquired during a heating mode was used to obtain the melting point. The melting point using this procedure was defined as the liquidus temperature.

The phase diagram is a graphical device that allows the composition and melting point of mixtures to be represented simultaneously (this type of phase diagram is called a polythermal projection). The typical phase diagram is triangular, which allows the plotting of a ternary system of three salts (typically four ions). Each corner of the triangle represents a pure ion and the interior area represents mixtures of varying proportions. The color represents the melting point. A quaternary system of four salts (typically five ions) may be plotted by a series of triangular phase diagrams (Phase Diagrams for Ceramists, vol. 1, describes such diagrams for up to six ions). The location of each ternary diagram along a horizontal axis represents the proportion of the 5^{th} ion. A quinary system of five salts (typically six ions) may be plotted by a two dimensional surface of ternary phase diagrams. Each ternary phase diagram is located at the (x, y) coordinates corresponding to the level of the 5^{th} and 6^{th} ions (ion 5, ion 6). A system of six salts (typically seven ions) may be plotted by a series of two dimensional surfaces of ternary phase diagrams. Each surface represents a constant value of the 7^{th} ion. The drawings included herein show representative phase diagrams for exemplary compositions.

Certain mixtures were subjected to further testing for thermal stability. Approximately 500 g of each mixture was synthesized and placed in a ceramic crucible. The water of crystallization was removed and the melt was formed at 325° C. in a muffle furnace. Then a ceramic lid was placed on top of the crucible. The crucible was heated for 92 hours at 700° C. in an air atmosphere. After the test the samples were analyzed by qualitative visual observation, weight loss measurement, and change in pH (an increasing pH would indicate decomposition to basic components).

### Example 1

To prepare laboratory-scale samples of the salt mixtures, each salt component was dispensed into a well on a borosilicate glass plate. The samples were heated in a furnace at a temperature of 175° C. for 2 hours and raised to 400° C. for 8 hours to melt and homogenize the sample. The sample was maintained at 115° C. after melting until it was removed from the furnace and allowed to cool to room temperature in a desiccator. The sample was inserted into the PMP Workstation and the temperature was set to 100° C. and allowed to stabilize for 60 minutes. The temperature was then ramped to 315° C. at 20° C./hour.

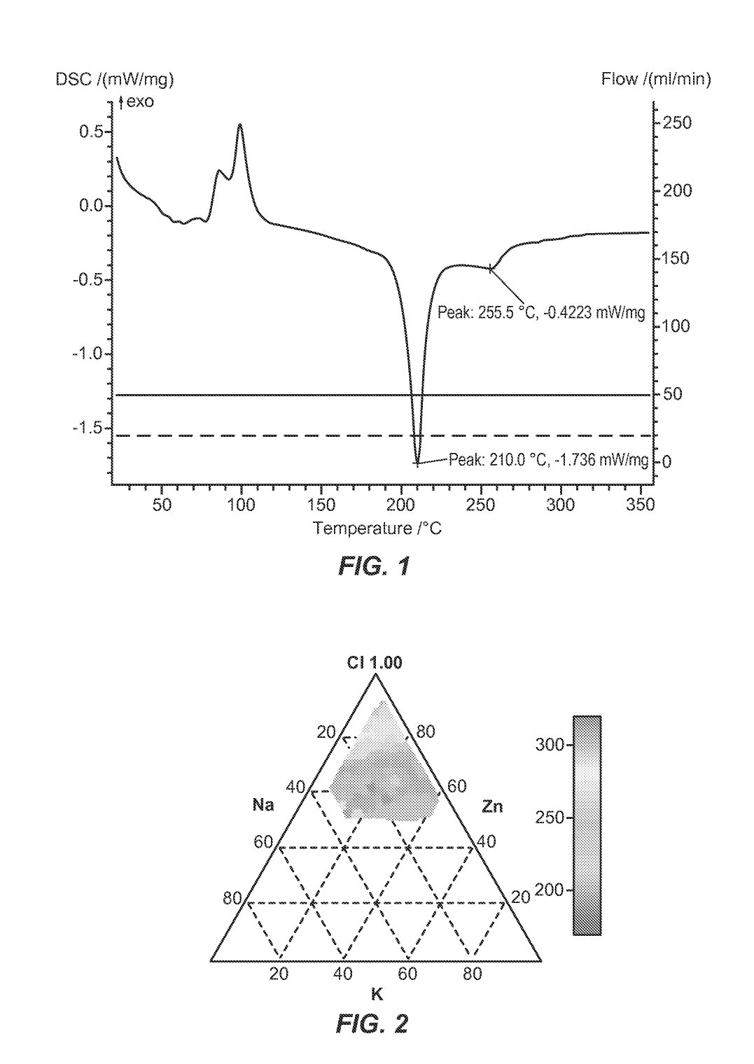

Salt compositions can be described by specifying the mass of each salt component, which can be translated to molar percent of each ion by those skilled in the art. A salt mixture of any desired size with the same properties (melting point and thermal stability) can be prepared by increasing the amount of each component but maintaining the relative proportions. FIG. 1 shows a differential scanning calorimetry (DSC) trace for a sample containing 22.8 mol % sodium, 33.6 mol % potassium, and 43.6 mol % zinc, based on the cations. The sample contains 100% mol chloride, based on the anions. Thermal stability testing of a larger 500 g batch of this composition resulted in no qualitative change in appearance after 92 hours at 700° C. Weight loss was less than 0.2%. The salt may be thermally stable at even higher temperatures. Subsequent tests at 850° C. showed similar results.

### Example 2

Further examples of each system are given below in Tables 1-4 below. These examples are not intended to restrict the scope of the present invention but merely illustrate possible embodiments; other compositions are possible. The composition of each is expressed in molar percent on an ion basis, which can be converted to weight percent by those skilled in the art. The melting point is expressed in degrees Celsius as measured by the PMP.

TABLE 1
Composition and Melting Point Data for Na—K—Zn—Cl Mixtures

| | Na | K | Zn | Cl | Melting |
|---|---|---|---|---|---|
| No. | (mol %) | (mol %) | (mol %) | (mol %) | Point (° C.) |
| 1 | 1.3 | 5.2 | 93.5 | 100.0 | 295.85 |
| 2 | 1.5 | 30.2 | 68.2 | 100.0 | 258.05 |
| 3 | 4.8 | 18.9 | 76.2 | 100.0 | 262.55 |
| 4 | 9.0 | 5.2 | 85.8 | 100.0 | 283.95 |
| 5 | 8.3 | 30.3 | 61.4 | 100.0 | 239.45 |
| 6 | 11.8 | 17.5 | 70.6 | 100.0 | 243.75 |
| 7 | 14.3 | 8.0 | 77.7 | 100.0 | 273.35 |
| 8 | 14.6 | 34.8 | 50.6 | 100.0 | 223.85 |
| 9 | 17.7 | 27.2 | 55.1 | 100.0 | 215.45 |
| 10 | 21.2 | 24.6 | 54.2 | 100.0 | 215.35 |
| 11 | 23.9 | 24.2 | 51.8 | 100.0 | 212.75 |
| 12 | 31.0 | 8.7 | 60.3 | 100.0 | |
| 13 | 2.3 | 8.6 | 89.1 | 100.0 | 286.05 |
| 14 | 2.3 | 33.4 | 64.3 | 100.0 | |
| 15 | 5.4 | 21.0 | 73.6 | 100.0 | 251.45 |
| 16 | 8.7 | 8.3 | 82.9 | 100.0 | 283.05 |
| 17 | 8.6 | 33.6 | 57.8 | 100.0 | 214.45 |
| 18 | 12.0 | 20.8 | 67.2 | 100.0 | 219.75 |
| 19 | 15.5 | 12.1 | 72.4 | 100.0 | 257.65 |
| 20 | 17.5 | 6.1 | 76.4 | 100.0 | 271.15 |
| 21 | 18.1 | 30.4 | 51.6 | 100.0 | 221.35 |
| 22 | 21.3 | 27.0 | 51.7 | 100.0 | 216.05 |
| 23 | 27.3 | 4.9 | 67.8 | 100.0 | 246.25 |
| 24 | 30.5 | 11.5 | 58.0 | 100.0 | 293.95 |
| 25 | 1.9 | 14.8 | 83.3 | 100.0 | 283.15 |
| 26 | 1.8 | 37.0 | 61.3 | 100.0 | 246.15 |
| 27 | 4.8 | 24.5 | 70.7 | 100.0 | 248.65 |
| 28 | 8.4 | 11.7 | 79.8 | 100.0 | 275.95 |
| 29 | 8.1 | 37.0 | 54.9 | 100.0 | 216.15 |
| 30 | 11.4 | 24.0 | 64.6 | 100.0 | 289.25 |
| 31 | 14.5 | 14.8 | 70.7 | 100.0 | 247.75 |
| 32 | 18.0 | 8 5 | 73.5 | 100.0 | 272.95 |
| 33 | 21.4 | 5.1 | 73.5 | 100.0 | 269.65 |
| 34 | 24.3 | 5.8 | 69.9 | 100.0 | 255.95 |
| 35 | 27.4 | 8.4 | 64.3 | 100.0 | 223.35 |
| 36 | 30.6 | 14.6 | 54.8 | 100.0 | 206.25 |
| 37 | 2.1 | 15.6 | 82.3 | 100.0 | 276.65 |
| 38 | 2.1 | 40.8 | 57.1 | 100.0 | 232.55 |
| 39 | 5.0 | 27.1 | 67.9 | 100.0 | 245.95 |
| 40 | 8.0 | 14.7 | 77.3 | 100.0 | 269.15 |
| 41 | 8.7 | 40.0 | 51.3 | 100.0 | 221.15 |
| 42 | 11.5 | 27.5 | 61.0 | 100.0 | 240.75 |
| 43 | 15.2 | 18.2 | 66.5 | 100.0 | 227.25 |
| 44 | 17.8 | 11.8 | 70.4 | 100.0 | 234.45 |
| 45 | 21.5 | 9.0 | 69.5 | 100.0 | 251.25 |
| 46 | 24.2 | 8.0 | 67.8 | 100.0 | 243.35 |
| 47 | 27.6 | 11.3 | 61.1 | 100.0 | 231.75 |
| 48 | 30.5 | 17.5 | 52.0 | 100.0 | 273.05 |
| 49 | 1.5 | 17.8 | 80.6 | 100.0 | 276.45 |
| 50 | 4.9 | 5.0 | 90.1 | 100.0 | 292.25 |
| 51 | 5.6 | 30.3 | 64.1 | 100.0 | 248.45 |
| 52 | 9.3 | 18.7 | 72.1 | 100.0 | 250.45 |
| 53 | 11.4 | 5.4 | 83.2 | 100.0 | 287.45 |
| 54 | 11.6 | 31.4 | 57.0 | 100.0 | 216.55 |
| 55 | 16.4 | 20.6 | 63.0 | 100.0 | 224.85 |
| 56 | 17.9 | 15.4 | 66.7 | 100.0 | 225.65 |
| 57 | 21.2 | 11.4 | 67.4 | 100.0 | 236.25 |
| 58 | 24.5 | 11.3 | 64.2 | 100.0 | 219.35 |
| 59 | 27.6 | 14.8 | 57.6 | 100.0 | 203.75 |
| 60 | 33.9 | 4.8 | 61.3 | 100.0 | 235.65 |
| 61 | 1.8 | 21.1 | 77.0 | 100.0 | 263.85 |
| 62 | 5.5 | 9.4 | 85.1 | 100.0 | 282.55 |
| 63 | 5.0 | 33.8 | 61.7 | 100.0 | 242.75 |
| 64 | 8.2 | 21.3 | 70.5 | 100.0 | 246.05 |
| 65 | 11.2 | 8.0 | 80.8 | 100.0 | 280.75 |
| 66 | 12.3 | 33.4 | 54.2 | 100.0 | 219.75 |
| 67 | 14.8 | 24.5 | 60.7 | 100.0 | 217.35 |
| 68 | 18.6 | 18.1 | 63.3 | 100.0 | 239.05 |
| 69 | 21.2 | 14.4 | 64.4 | 100.0 | 219.55 |
| 70 | 24.0 | 15.5 | 60.5 | 100.0 | 210.75 |
| 71 | 27.5 | 18.3 | 54.2 | 100.0 | 243.55 |
| 72 | 33.8 | 8.2 | 58.0 | 100.0 | 227.15 |
| 73 | 1.9 | 24.9 | 73.3 | 100.0 | 253.05 |
| 74 | 5.2 | 11.2 | 83.6 | 100.0 | 276.15 |
| 75 | 6.1 | 36.7 | 57.2 | 100.0 | 214.35 |
| 76 | 8.5 | 25.1 | 66.4 | 100.0 | 236.25 |
| 77 | 11.6 | 11.6 | 76.7 | 100.0 | 272.05 |
| 78 | 12.0 | 36.9 | 51.1 | 100.0 | 223.85 |
| 79 | 14.6 | 27.6 | 57.9 | 100.0 | 208.05 |
| 80 | 17.6 | 21.1 | 61.3 | 100.0 | 206.85 |
| 81 | 20.8 | 18.0 | 61.2 | 100.0 | 198.85 |
| 82 | 24.0 | 18.6 | 57.4 | 100.0 | 206.65 |
| 83 | 27.0 | 21.6 | 51.4 | 100.0 | 211.85 |
| 84 | 33.8 | 11.9 | 54.3 | 100.0 | 276.35 |
| 85 | 1.6 | 28.0 | 70.4 | 100.0 | 256.95 |
| 86 | 5.7 | 14.7 | 79.6 | 100.0 | 273.55 |
| 87 | 5.5 | 39.9 | 54.6 | 100.0 | 215.15 |
| 88 | 8.7 | 27.4 | 64.0 | 100.0 | 234.55 |
| 89 | 11.4 | 14.5 | 74.1 | 100.0 | 255.55 |
| 90 | 14.5 | 4.9 | 80.6 | 100.0 | 281.65 |
| 91 | 14.6 | 31.0 | 54.4 | 100.0 | 215.85 |
| 92 | 17.5 | 25.3 | 57.3 | 100.0 | 202.25 |
| 93 | 20.9 | 21.5 | 57.6 | 100.0 | 207.55 |
| 94 | 24.2 | 21.3 | 54.5 | 100.0 | 205.95 |
| 95 | 30.4 | 5.1 | 64.6 | 100.0 | 237.85 |
| 96 | 33.8 | 14.5 | 51.7 | 100.0 | 204.05 |

The melting point data, for compositions in Table 1 are plotted as the phase diagram shown in FIG. 2.

TABLE 2
Composition and Melting Point Data for Na—K—Zn—Cl Mixtures

| | Na | K | Zn | Cl | Melting |
|---|---|---|---|---|---|
| No. | (mol %) | (mol %) | (mol %) | (mol %) | Point (° C.) |
| 97 | 10.8 | 10.1 | 79.1 | 100.0 | 271.45 |
| 98 | 9.8 | 42.1 | 48.1 | 100.0 | 252.15 |
| 99 | 10.2 | 72.1 | 17.6 | 100.0 | |
| 100 | 14.0 | 29.7 | 56.3 | 100.0 | 213.55 |
| 101 | 14.1 | 60.5 | 25.4 | 100.0 | |
| 102 | 18.5 | 21.9 | 59.6 | 100.0 | 185.65 |
| 103 | 17.5 | 53.1 | 29.4 | 100.0 | |
| 104 | 22.3 | 18.5 | 59.2 | 100.0 | 237.05 |
| 105 | 22.2 | 48.8 | 29.0 | 100.0 | |
| 106 | 25.1 | 19.1 | 55.7 | 100.0 | 208.95 |
| 107 | 25.3 | 49.5 | 25.2 | 100.0 | |
| 108 | 29.3 | 22.2 | 48.5 | 100.0 | 269.45 |
| 109 | 9.7 | 15.6 | 74.7 | 100.0 | 259.25 |
| 110 | 10.4 | 44.6 | 45.0 | 100.0 | |
| 111 | 9.7 | 76.6 | 13.7 | 100.0 | |
| 112 | 13.7 | 33.9 | 52.4 | 100.0 | 221.55 |
| 113 | 13.8 | 65.0 | 21.3 | 100.0 | |
| 114 | 18.2 | 26.2 | 55.7 | 100.0 | 211.45 |
| 115 | 17.6 | 57.2 | 25.3 | 100.0 | |
| 116 | 21.3 | 23.2 | 55.6 | 100.0 | 211.55 |
| 117 | 22.5 | 52.7 | 24.8 | 100.0 | |
| 118 | 25.8 | 21.9 | 52.3 | 100.0 | 212.95 |
| 119 | 25.5 | 53.1 | 21.5 | 100.0 | |
| 120 | 30.2 | 25.0 | 44.8 | 100.0 | 219.85 |
| 121 | 9.4 | 19.2 | 71.4 | 100.0 | 244.95 |
| 122 | 10.1 | 49.3 | 40.7 | 100.0 | 208.35 |
| 123 | 10.0 | 80.2 | 9.8 | 100.0 | |
| 124 | 13.6 | 38.6 | 47.8 | 100.0 | 212.85 |
| 125 | 14.9 | 67.8 | 17.3 | 100.0 | |
| 126 | 18.5 | 30.0 | 51.5 | 100.0 | 218.95 |
| 127 | 17.7 | 60.9 | 21.3 | 100.0 | |
| 128 | 21.2 | 26.4 | 52.4 | 100.0 | 218.35 |
| 129 | 21.4 | 57.2 | 21.5 | 100.0 | |
| 130 | 25.1 | 26.9 | 48.0 | 100.0 | 220.05 |
| 131 | 25.5 | 56.9 | 17.6 | 100.0 | |
| 132 | 29.6 | 29.7 | 40.7 | 100.0 | 208.35 |
| 133 | 9.5 | 21.6 | 68.9 | 100.0 | |
| 134 | 10.3 | 53.0 | 36.7 | 100.0 | 206.75 |
| 135 | 13.7 | 12.4 | 73.9 | 100.0 | 261.55 |
| 136 | 14.1 | 41.8 | 44.1 | 100.0 | 208.85 |
| 137 | 14.1 | 72.3 | 13.6 | 100.0 | |
| 138 | 17.6 | 34.3 | 48.1 | 100.0 | 213.85 |
| 139 | 18.0 | 64.4 | 17.7 | 100.0 | |
| 140 | 21.4 | 30.5 | 48.1 | 100.0 | 218.95 |
| 141 | 72.3 | 60.3 | 17.4 | 100.0 | |
| 142 | 25.4 | 30.4 | 44.3 | 100.0 | 207.55 |
| 143 | 25.9 | 60.3 | 13.8 | 100.0 | |
| 144 | 29.0 | 34.4 | 36.7 | 100.0 | 286.55 |
| 145 | 10.0 | 26.9 | 63.1 | 100.0 | |
| 146 | 16.5 | 53.1 | 30.5 | 100.0 | 265.85 |
| 147 | 16.3 | 14.3 | 69.4 | 100.0 | 243.25 |
| 148 | 14.0 | 45.3 | 40.7 | 100.0 | 306.25 |
| 149 | 13.7 | 76.3 | 9.9 | 100.0 | |
| 150 | 17.8 | 38.2 | 44.1 | 100.0 | 228.75 |
| 151 | 18.0 | 68.1 | 13.9 | 100.0 | |
| 152 | 22.8 | 33.6 | 43.6 | 100.0 | 209.55 |
| 153 | 21.9 | 64.3 | 13.8 | 100.0 | |
| 154 | 26.0 | 33.0 | 41.0 | 100.0 | 262.55 |
| 155 | 25.8 | 64.2 | 9.9 | 100.0 | |
| 156 | 30.1 | 36.9 | 33.0 | 100.0 | 278.05 |
| 157 | 9.8 | 29.3 | 60.9 | 100.0 | 204.95 |
| 158 | 10.0 | 61.1 | 28.9 | 100.0 | |
| 159 | 14.1 | 18.3 | 67.6 | 100.0 | 225.35 |
| 160 | 15.5 | 47.9 | 36.6 | 100.0 | 265.65 |
| 161 | 18.4 | 10.0 | 71.6 | 100.0 | 254.65 |
| 162 | 18.4 | 41.1 | 40.4 | 100.0 | 280.05 |
| 163 | 17.8 | 72.2 | 10.0 | 100.0 | |
| 164 | 21.8 | 37.4 | 40.8 | 100.0 | 265.25 |
| 165 | 21.9 | 68.2 | 9.9 | 100.0 | |
| 166 | 24.8 | 38.7 | 36.5 | 100.0 | 265.35 |
| 167 | 29.9 | 11.4 | 58.7 | 100.0 | 257.65 |
| 168 | 29.3 | 41.8 | 28.9 | 100.0 | 265.35 |
| 169 | 9.4 | 35.0 | 55.6 | 100.0 | 209.85 |
| 170 | 10.4 | 64.6 | 25.1 | 100.0 | |
| 171 | 14.1 | 21.4 | 64.5 | 100.0 | 200.05 |
| 172 | 14.0 | 52.7 | 33.3 | 100.0 | 208.35 |
| 173 | 18.0 | 14.1 | 67.8 | 100.0 | 233.95 |
| 174 | 18.1 | 44.9 | 37.0 | 100.0 | 265.35 |
| 175 | 23.1 | 9.9 | 67.0 | 100.0 | 234.65 |
| 176 | 22.6 | 40.6 | 36.8 | 100.0 | 265.55 |
| 177 | 25.7 | 10.9 | 63.4 | 100.0 | 208.45 |
| 178 | 25.4 | 42.2 | 32.4 | 100.0 | 265.35 |
| 179 | 28.8 | 15.0 | 56.2 | 100.0 | 204.45 |
| 180 | 29.1 | 45.8 | 25.1 | 100.0 | 278.75 |
| 181 | 10.0 | 37.6 | 52.4 | 100.0 | 219.55 |
| 182 | 10.3 | 68.4 | 21.4 | 100.0 | |
| 183 | 13.7 | 26.8 | 59.6 | 100.0 | 201.75 |
| 184 | 14.1 | 57.2 | 28.7 | 100.0 | |
| 185 | 18.0 | 19.3 | 62.7 | 100.0 | 192.25 |
| 186 | 17.3 | 49.9 | 32.8 | 100.0 | 265.55 |
| 187 | 23.8 | 14.9 | 61.4 | 100.0 | 232.05 |
| 188 | 21.5 | 45.6 | 32.9 | 100.0 | 266.35 |
| 189 | 25.5 | 15.2 | 59.3 | 100.0 | 198.15 |
| 190 | 25.7 | 45.3 | 29.1 | 100.0 | 265.65 |
| 191 | 29.1 | 18.9 | 52.0 | 100.0 | 212.55 |
| 192 | 29.7 | 48.9 | 21.4 | 100.0 | |

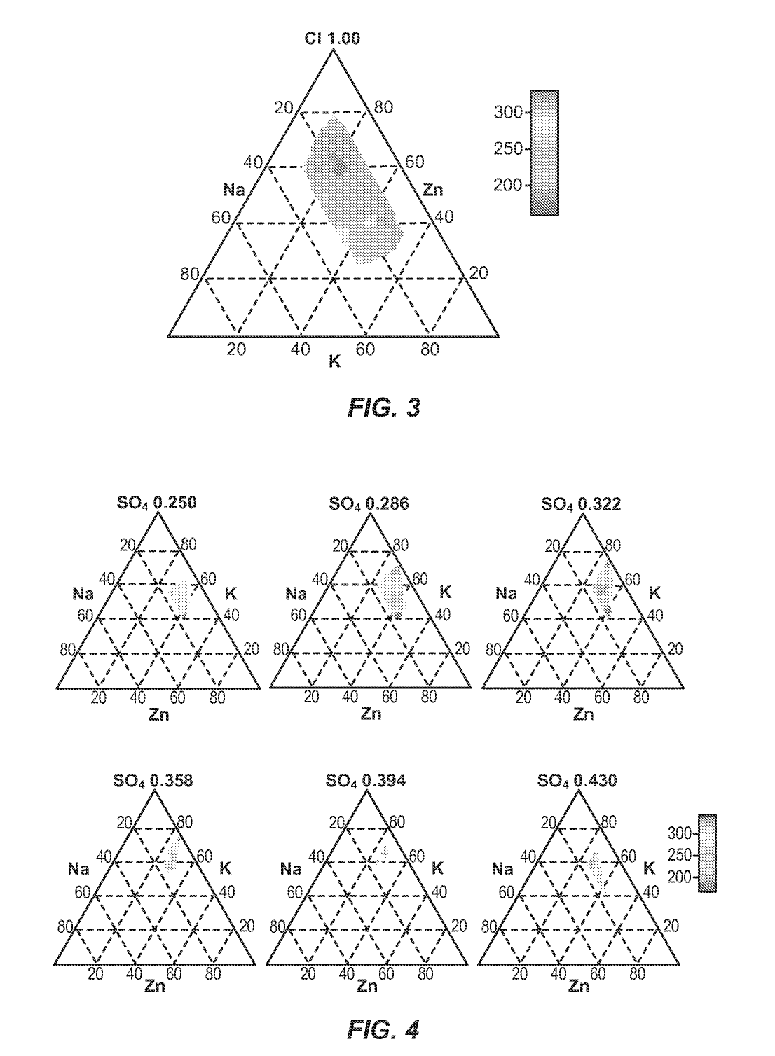

The melting point data for compositions in Table 2 are plotted as the phase diagram shown in FIG. 3.

TABLE 3
Composition and Melting Point Data for
Na—K—Zn—Cl—SO₄ Mixtures

| | Na | K | Zn | SO₄ | Cl | Melting |
|---|---|---|---|---|---|---|
| No. | (mol %) | (mol %) | (mol %) | (mol %) | (mol %) | Point (° C.) |
| 192 | 16.2 | 42 9 | 40.9 | 24.8 | 75.2 | |
| 193 | 16.4 | 43.0 | 40.6 | 32.4 | 67.6 | |
| 194 | 16.1 | 43.1 | 40.9 | 28.7 | 71.3 | |
| 195 | 13.6 | 24.5 | 61.9 | 38.7 | 61.3 | 288.75 |
| 196 | 8.2 | 43.1 | 48.7 | 28.7 | 71.3 | 288.75 |
| 197 | 15.7 | 28.7 | 55.6 | 40.0 | 60.0 | 289.35 |
| 198 | 16.4 | 32.0 | 51.6 | 25.9 | 74.1 | 289.65 |
| 199 | 11.8 | 32.1 | 56.1 | 29.3 | 70.7 | 289.75 |
| 200 | 12.1 | 25.2 | 62.6 | 36.2 | 63.8 | 289.75 |
| 201 | 16.2 | 43.1 | 40.7 | 43.0 | 57.0 | 289.85 |
| 202 | 12.5 | 28.4 | 59.1 | 24.9 | 75.1 | 289.95 |
| 203 | 16.2 | 24.9 | 58.9 | 28.4 | 71.6 | 289.95 |
| 204 | 10.6 | 34.7 | 54.8 | 31.4 | 68.6 | 290.15 |
| 205 | 8.3 | 28.4 | 63.4 | 39.4 | 60.6 | 290.85 |

The melting point data for compositions in Table 3 are plotted as the phase diagrams shown in FIG. 4.

TABLE 4
Composition and Thermal Data for
Na—K—Zn—Cl—SO₄ Mixtures

| | Na | K | Zn | SO₄ | Cl | | | Cₚ |
|---|---|---|---|---|---|---|---|---|
| | (mol | (mol | (mol | (mol | (mol | MP | ΔH_{fus} | (J/(g · |
| No. | %) | %) | %) | %) | %) | (° C.) | (J/g) | ° C.) |
| 206 | 12.3 | 24.3 | 63.5 | 2.1 | 97.9 | 255 | 93.5 | |
| 207 | 25.7 | 9.8 | 64.5 | 3.0 | 97.0 | 243 | 52.4 | |
| 208 | 25.0 | 11.0 | 64.0 | 4.1 | 95.9 | 236 | 25.4 | |
| 209 | 0.0 | 38.0 | 62.0 | 2.0 | 98.0 | 242 | 61.9 | |
| 210 | 22.8 | 33.6 | 43.6 | 0.0 | 100.0 | 257 | 87.2 | 0.79 |
| 211 | 25.1 | 26.9 | 48.0 | 0.0 | 100.0 | 220 | | |
| 212 | 21.4 | 30.5 | 48.1 | 0.0 | 100.0 | 219 | | |
| 213 | 17.8 | 38.2 | 44.1 | 0.0 | 100.0 | 229 | | |
| 214 | 18.5 | 21.9 | 59.6 | 0.0 | 100.0 | 186 | | |

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A method for storing thermal energy comprising heating a composition with thermal energy, wherein the composition comprises:
a sodium cation, in an amount of from about 0 to about 40 mol % based on the cations;
a potassium cation, in an amount of from about 1 to about 90 mol % based on the cations;
a zinc cation, in an amount of from about 5 to about 95 mol % based on the cations;
a chloride anion in an amount of from about 40 to about 100 mol % based on the anions; and
a sulfate anion in an amount of from about 0 to about 60 mol % based on the anions;
thereby causing the temperature of the composition to increase.

2. The method of claim 1, wherein the composition comprises:
the sodium cation, in an amount of from about 1 to about 40 mol % based on the cations;
the potassium cation, in an amount of from about 1 to about 90 mol % based on the cations;
the zinc cation, in an amount of from about 5 to about 95 mol % based on the cations;
the chloride anion in an amount of from about 40 to about 99 mol % based on the anions; and
the sulfate anion in an amount of from about 1 to about 60 mol % based on the anions.

3. The method of claim 2, wherein the composition comprises:
the sodium cation, in an amount of from about 8 to about 16 mol % based on the cations;
the potassium cation, in an amount of from about 40 to about 64 mol % based on the cations;
the zinc cation, in an amount of from about 24 to about 44 mol % based on the cations;
the chloride anion, in an amount of from about 55 to about 75 mol % based on the anions; and
the sulfate anion, in an amount of from about 25 to about 45 mol % based on the anions.

4. The method of claim 2, wherein the composition comprises:
the sodium cation, in an amount of from about 8 to about 16 mol % based on the cations;
the potassium cation, in an amount of from about 40 to about 64 mol % based on the cations;
the zinc cation, in an amount of from about 44 to about 62 mol % based on the cations;
the chloride anion, in an amount of from about 55 to about 75 mol % based on the anions; and
the sulfate anion, in an amount of from about 25 to about 45 mol % based on the anions.

5. The method of claim 2, wherein the composition comprises:
the sodium cation, in an amount of from about 0 to about 26 mol % based on the cations;
the potassium cation, in an amount of from about 8 to about 40 mol % based on the cations;
the zinc cation, in an amount of from about 60 to about 66 mol % based on the cations;
the chloride anion, in an amount of from about 95 to about 99 mol % based on the anions; and
the sulfate anion, in an amount of from about 1 to about 5 mol % based on the anions.

6. The method of claim 1, wherein the composition comprises:
the sodium cation, in an amount of from about 1 to about 40 mol % based on the cations;
the potassium cation, in an amount of from about 1 to about 90 mol % based on the cations;
the zinc cation, in an amount of from about 5 to about 95 mol % based on the cations; and
the chloride anion in an amount of about 100 mol % based on the anions.

7. The method of claim 6, wherein the composition comprises:
the sodium cation, in an amount of from about 10 to about 34 mol % based on the cations;
the potassium cation, in an amount of from about 5 to about 41 mol % based on the cations; and
the zinc cation, in an amount of from about 50 to about 94 mol % based on the cations.

8. The method of claim 6, wherein the composition comprises:
the sodium cation, in an amount of from about 10 to about 30 mol % based on the cations;
the potassium cation, in an amount of from about 10 to about 80 mol % based on the cations; and
the zinc cation, in an amount of from about 10 to about 80 mol % based on the cations.

9. The method of claim 6, wherein the composition comprises:
the sodium cation, in an amount of from about 16 to about 26 mol % based on the cations;
the potassium cation, in an amount of from about 20 to about 40 mol % based on the cations; and
the zinc cation, in an amount of from about 42 to about 60 mol % based on the cations.

10. The method of claim 1, wherein the composition comprises:
the sodium cation, in an amount of about 23 mol % based on the cations;
the potassium cation, in an amount of about 33 mol % based on the cations;
the zinc cation, in an amount of about 44 mol % based on the cations; and
the chloride anion in an amount of about 100% based on the anions.

11. The method of claim 1, wherein the composition comprises:
the sodium cation, in an amount of about 20 mol % based on the cations;
the potassium cation, in an amount of about 20 mol % based on the cations;
the zinc cation, in an amount of about 60 mol % based on the cations; and
the chloride anion in an amount of about 100% based on the anions.

12. The method of claim 1, wherein the thermal energy originates from a source selected from the group consisting of sunlight, a concentrated solar power plant, a fossil fuel power plant, fuel combustion, and a heat pump.

13. A composition comprising:
a sodium cation, in an amount of from about 0 to about 40 mol % based on the cations;
a potassium cation, in an amount of from about 1 to about 90 mol % based on the cations;
a zinc cation, in an amount of from about 5 to about 95 mol % based on the cations;
a chloride anion in an amount of from about 40 to about 99 mol % based on the anions; and
a sulfate anion in an amount of from about 1 to about 60 mol % based on the anions.

14. The composition of claim 13, wherein the sodium cation is present in an amount of from about 0 to about 28 mol % based on the cations.

15. The composition of claim 13, wherein the sodium cation is present in an amount of from about 5 to about 20 mol % based on the cations.

16. The composition of claim 13, wherein the potassium cation is present in an amount of from about 8 to about 40 mol % based on the cations.

17. The composition of claim 13, wherein the potassium cation is present in an amount of from about 35 to about 65 mol % based on the cations.

18. The composition of claim 13, wherein the zinc cation is present in an amount of from about 20 to about 68 mol % based on the cations.

19. The composition of claim 13, wherein the zinc cation is present in an amount of from about 60 to about 65 mol % based on the cations.

20. The composition of claim 13, wherein the chloride anion is present in an amount of from about 95 to about 99 mol % based on the anions.

21. The composition of claim 13, wherein the chloride anion is present in an amount of from about 50 to about 80 mol % based on the anions.

22. The composition of claim 13, wherein the sulfate anion is present in an amount of from about 1 to about 5 mol % based on the anions.

23. The composition of claim 13, wherein the sulfate anion is present in an amount of from about 20 to about 45 mol % based on the anions.

24. The composition of claim 13, comprising
the sodium cation, in an amount of from about 8 to about 16 mol % based on the cations;
the potassium cation, in an amount of from about 40 to about 64 mol % based on the cations;
the zinc cation, in an amount of from about 24 to about 44 mol % based on the cations;
the chloride anion, in an amount of from about 55 to about 75 mol % based on the anions; and
the sulfate anion, in an amount of from about 25 to about 45 mol % based on the anions.

25. The composition of claim 13, comprising
the sodium cation, in an amount of from about 8 to about 16 mol % based on the cations;
the potassium cation, in an amount of from about 40 to about 64 mol % based on the cations;
the zinc cation, in an amount of from about 44 to about 62 mol % based on the cations;
the chloride anion, in an amount of from about 55 to about 75 mol % based on the anions; and
the sulfate anion, in an amount of from about 25 to about 45 mol % based on the anions.

26. The composition of claim 13, comprising
the sodium cation, in an amount of from about 0 to about 26 mol % based on the cations;
the potassium cation, in an amount of from about 8 to about 40 mol % based on the cations;
the zinc cation, in an amount of from about 60 to about 66 mol % based on the cations;
the chloride anion, in an amount of from about 95 to about 99 mol % based on the anions; and
the sulfate anion, in an amount of from about 1 to about 5 mol % based on the anions.

27. The composition of claim 13, wherein the melting point is less than about 300° C.

28. The composition of claim 27, wherein the melting point is about 200° C.

29. The composition of claim 13, wherein the thermal stability limit is at least about 700° C.
